(19) United States
(12) Patent Application Publication
(10) Pub. No.: US 2017/0053278 A1
(43) Pub. Date: Feb. 23, 2017

(54) Systems and Methods for Processing Charges for Disputed Transactions

(71) Applicant: MASTERCARD INTERNATIONAL INCORPORATED, Purchase, NY (US)

(72) Inventors: Jean-Pierre Gerard, Croton-On-Hudson, NY (US); Po Hu, Norwalk, CT (US)

(21) Appl. No.: 14/832,389

(22) Filed: Aug. 21, 2015

(51) Int. Cl. G06Q 20/40

(52) U.S. Cl. CPC G06Q 20/407

(57) ABSTRACT

Systems and methods are provided for processing a charge for a disputed transaction to a payment account associated with a consumer. In connection therewith, a refund request is initially received, from the consumer, relating to a transaction at a merchant charged to the consumer's payment account. The refund request includes an amount of the disputed transaction charged to the consumer's payment account. Next, a dispute score is generated for the refund request, and compared to a defined threshold. At least one of the dispute score and the defined threshold is based on a variable other than (i.e., potentially in addition to) the amount of the transaction. When the dispute score is less than, or more generally satisfies, the threshold, a dispute settlement indicator is generated for the transaction without causing a chargeback transaction to an acquirer associated with the merchant.

### FIELD

The present disclosure generally relates to systems and methods for processing charges for disputed transactions and, in particular, for evaluating refund requests from consumers in connection with such disputed transactions.

### BACKGROUND

This section provides background information related to the present disclosure which is not necessarily prior art.

Purchases of products, e.g., goods and services, are often funded through transactions to payment accounts. In general, transactions are coordinated through merchants (offering the products for purchase), acquirers associated with the merchants, one or more service providers (or payment network interchanges), and issuers of the payment accounts.

When consumers suspect that their payment accounts have been incorrectly charged for one or more transactions, or have been charged for transactions they did not initiate, the consumers typically request that the issuers of the payment accounts reverse the charges, in the form of a refund, etc.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in processing charges for disputed transactions from consumers;

FIG. 2 is a block diagram of a computing device that may be used in the exemplary system of FIG. 1; and

FIG. 3 is an exemplary method suitable for use with the system of FIG. 1, for processing a charge for a disputed transaction from a consumer.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Consumers often enter into transactions with merchants to purchase products, e.g., goods and services. However, in some cases, the consumers believe that their payment accounts have been incorrectly charged for such transactions, or that their payment accounts have been charged for transactions to which the consumer was not a participant. In response, the consumers dispute the transactions by notifying issuers of the payment accounts and requesting that the charges associated with the disputed transactions be reversed, or refunded to the payment accounts. As can be appreciated, for the issuers, payment networks, and others, addressing such requests can be costly and time consuming. The systems and methods described herein generally operate to generate an approximation of costs, or representative scores, for such refund requests from each of the consumers and then, using the approximated costs (or scores), relative to a threshold, to determine whether to actually investigate the consumers' refund requests in detail, or simply approve the refund requests and credit the consumers' payment accounts as requested. The thresholds and/or approximated costs may be different, for each transaction, based on one or more variables, such as, for example, longevity of the account at the issuer, consumer lifetime value for the consumer at the issuer, dispute history for the consumer and/or account, payment account type, etc. In this manner, variables that are more significant, potentially, than simply the amount of the requested refund, are factored into how to proceed.

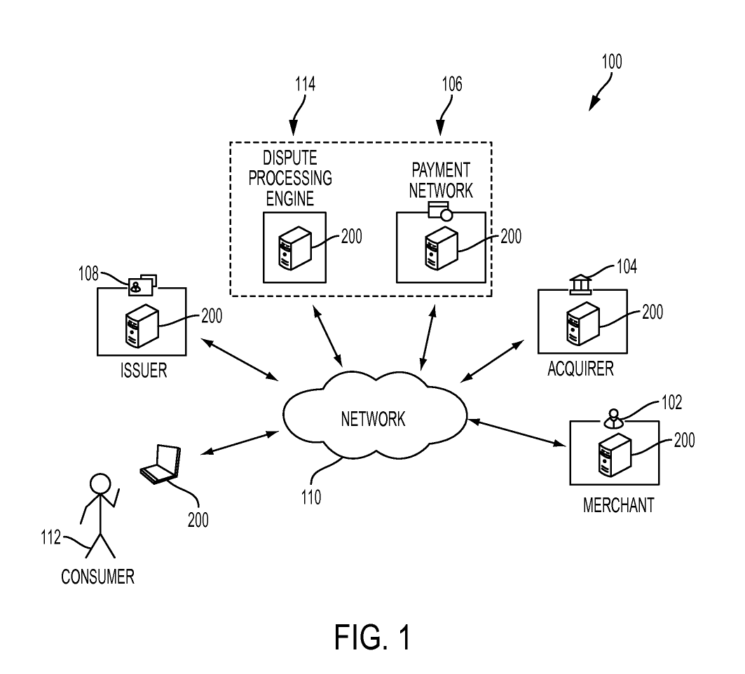

FIG. 1 illustrates an exemplary system 100 in which one or more aspects of the present disclosure may be implemented. Although components of the system 100 are presented in one arrangement, it should be appreciated that other exemplary embodiments may include the same or different components arranged otherwise, for example, depending on interactions and/or relationships between various components in the exemplary embodiments, processing of payment transactions in the exemplary embodiments, processing of chargeback transactions in the exemplary embodiments, etc.

As shown in FIG. 1, the illustrated system 100 generally includes a merchant 102, an acquirer 104 associated with the merchant 102, a payment network 106, and an issuer 108 of payment accounts, each coupled to network 110. The merchant 102 may include an online merchant, having a virtual location on the Internet (e.g., websites accessible through the network 110, etc.), or through web-based applications, etc., to permit consumers (e.g., consumer 112) to initiate transactions for products offered by the merchant 102 for purchase, etc. using payment accounts provided by the issuer 108. In addition, the merchant 102 may also include at least one brick-and-mortar location.

The system 100 also includes dispute processing engine 114 coupled to the network 110 and configured, often by computer executable instructions, generally, to process a refund request from the consumer 112 (or from other consumers supported by the system 100) for a charge to a payment account associated with the consumer 112. In connection therewith, the engine 114 is configured to generate a score, based on an approximated value for the refund request, and compare the score to a defined threshold. When the score satisfies the threshold, the engine 114 causes, directly or indirectly, a refund to be credited to the payment account associated with the consumer 112 (or causes an indicator suggesting that a refund should be credited to the payment account), without a chargeback transaction to the acquirer 104 or merchant 102.

However, when the score does not satisfy the threshold, the engine 114 instead causes a chargeback transaction for the refund request to be initiated (or causes an indicator to be generated suggesting that a chargeback transaction should be initiated). The request is then submitted through the acquirer 104 and the merchant 102, so that additional investigation can be performed as to the validity of the request.

In this manner, the engine 114 provides a suggestion to the issuer 108 of the payment account, or to another entity, based on the score generated for the request, as to whether or not it would be more appropriate to simply absorb the amount associated with the refund request, without further investigation, or if a chargeback transaction is warranted. These and other operations of the engine 114 will be described in more detail hereinafter.

It should be appreciated that, as used herein, approximated costs (and, thus the scores associated therewith) are estimates for values of the refund requests, as determined by the engine 114. In some cases, the approximated costs may be the refund amounts identified in the requests. In other cases, the approximated costs may take into account various different factors including, for example, the refund amounts identified in the requests as well as costs incurred by various entities in connection with processing the refund requests. In any case, generally, the approximated costs represent attempts, by the engine 114, to get as close as possible to true costs of the refund requests as possible.

The network 110 of the system 100 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. In one example, the network 110 includes multiple networks, where different ones of the multiple networks are accessible to different ones of the illustrated components in FIG. 1. For example, the network 110 may include a private payment transaction network made accessible by the payment network 106 to the acquirer 104 and the issuer 108, and separately, a network through which the merchant 102 and the consumer 112 communicate in performing purchase transactions and/or through which the consumer 112 and the issuer 108 communicate in connection with the consumer's payment account.

While only one merchant 102 and one consumer 112 are illustrated in FIG. 1, it should be appreciated that any number of merchants and/or consumers, as described herein, may be included in different embodiments. Likewise, a different number of acquirers, payment networks, and/or issuers may be included. For example, different merchants may have one or more different acquirers, and different consumers may employ payment accounts issued by one or more different issuers. Further, while the engine 114 is shown as a stand-alone entity in FIG. 1, it should be appreciated that the engine 114 may be associated with (or incorporated into) another entity shown in FIG. 1 such as the payment network 106 (as indicated by the broken lines in FIG. 1) or the issuer 108, or another entity not shown.

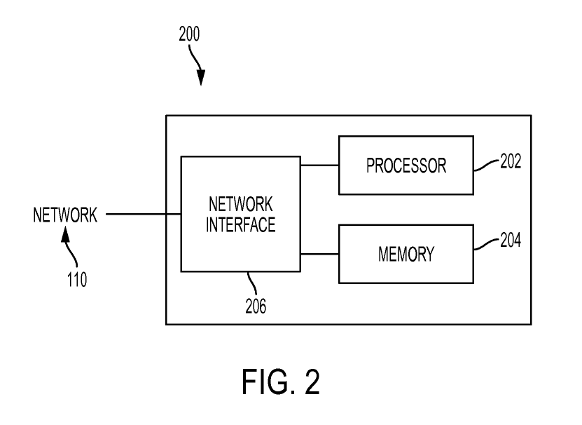

Each of the merchant 102, the acquirer 104, the payment network 106, the issuer 108, the consumer 112, and the engine 114 in the system 100 is associated with, or implemented in, one or more computing devices. For illustration, the system 100 is described herein with reference to exemplary computing device 200, illustrated in FIG. 2. Each of the merchant 102, the acquirer 104, the payment network 106, the issuer 108, the consumer 112, and the engine 114 in the system 100 is associated with such a computing device 200. However, the system 100 and its components should not be considered limited to the computing device 200, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region (such that each computing device 200 in the system 100 may represent multiple computing devices).

By way of example (and without limitation), the exemplary computing device 200 may include one or more servers, personal computers, laptops, tablets, PDAs, telephones (e.g., cellular phones, smartphones, other phones, etc.), point of sale (POS) terminals, combinations thereof, etc., as appropriate.

With reference now to FIG. 2, the computing device 200 generally includes a processor 202, and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may be configured to store, without limitation, transaction data, refund data, consumer data, merchant data, product data, dispute processing thresholds and algorithms related thereto, and/or other types of data suitable for use as described herein, etc. In addition, the memory 204 may include one or more computer-readable media, such as, without limitation, dynamic random access memory (DRAM), static random access memory (SRAM), read only memory (ROM), erasable programmable read only memory (EPROM), solid state devices (e.g., EMV chips, etc.), CD-ROMs, thumb drives, tapes, flash drives, hard disks, and/or any other type of volatile or nonvolatile physical or tangible computer-readable media. Further, computer-readable media may, in some embodiments, be selectively insertable to and/or removable from the computing device 200 to permit access to and/or execution by the processor 202 (although this is not required).

In various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The illustrated computing device 200 also includes a network interface 206 coupled to the processor 202 and the memory 204. The network interface 206 may include, without limitation, a wired network adapter, a wireless network adapter, a mobile telecommunications adapter, or other device capable of communicating to one or more different networks (e.g., the Internet, an intranet, a private or public LAN, WAN, mobile network, telecommunication networks, combinations thereof, or other suitable network, etc.) that is either part of the network 110, or separate therefrom. In some exemplary embodiments, the computing device 200 includes the processor 202 and one or more network interfaces incorporated into or with the processor 202.

In some exemplary embodiments, the computing device 200 may also include an output device and/or an input device coupled to the processor 202.

The output device, when present in the computing device 200, outputs information and/or data to a user by, for example, displaying, audibilizing, and/or otherwise outputting the information and/or data. In some embodiments, the output device may comprise a display device such that various interfaces (e.g., webpages, etc.) may be displayed at computing device 200, and in particular at the display device, to display such information and/or data, etc. And in some examples, the computing device 200 may also (or alternatively) cause the interfaces to be displayed at a display device of another computing device, including, for example, a server hosting a website having multiple webpages, etc. With that said, the output device may include, without limitation, a cathode ray tube (CRT), a liquid crystal display (LCD), a light-emitting diode (LED) display, an organic LED (OLED) display, an “electronic ink” display, speakers, combinations thereof, etc. In addition, the output device may include multiple devices.

The input device, when present in the computing device 200, is configured to receive input from a user. The input device may include, without limitation, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, may function as both an output device and an input device.

Referring again to FIG. 1, in the system 100, when the consumer 112 desires to purchase products from the merchant 102, the consumer 112 provides information about his/her payment account (e.g., a payment account number, etc.) to the merchant 102 via a payment device (e.g., a payment card, a fob, a smartphone, etc.), or via login credentials for a previously established purchase account (e.g., an electronic wallet such as MasterPass™, Google Wallet™, PayPass™, Softcard®, etc.), etc. The merchant 102 reads the payment account information and communicates, via the network 110, an authorization request to the payment network 106, via the acquirer 104 (associated with the merchant 102), to process the transaction (e.g., using the MasterCard® interchange, etc.). The authorization request includes various details of the transaction (e.g., transaction data, etc.) to help facilitate processing the authorization request. The payment network 106, in turn, communicates the authorization request to the issuer 108 (associated with the consumer's payment account). The issuer 108 then provides an authorization response (e.g., authorizing or declining the request) to the payment network 106, which is provided back through the acquirer 104 to the merchant 102. The transaction with the consumer 112 is then completed, or not, by the merchant 102, depending on the authorization response.

Also in the system 100, the consumer 112 may dispute a transaction (or charge) to his/her payment account, for example, involving the merchant 102, etc. for one or more reasons (e.g., the consumer 112 did not receive the purchased product from the merchant 102, or believes the received product is defective or damaged; the amount charged to the consumer's payment account for the transaction is incorrect; the consumer 112 does not recognize, or did not make, a payment transaction with the merchant 102 processed to his/her payment account, or was a victim of fraud; etc.). In so doing, the consumer 112 initially interacts with the issuer 108 to initiate a request (or claim) for a refund of the amount of the disputed transaction (e.g., provides payment account details to the issuer 108, details of the reason for making the request, etc.). The issuer 108 then transmits the request to the engine 114 for processing, as described herein. In various aspects, the issuer 108 may also credit the appropriate amount to the consumer's payment account prior to, or in conjunction with, transmitting the request to the engine 114. In addition, in various aspects, the issuer 108 may then process the transaction again, as appropriate, for example, depending on a determination of the engine 114 and/or a subsequent investigation of the dispute as performed by the issuer 108 or another entity.

Generally, though, in connection with processing the disputed transaction, when the engine 114 determines that the refund request, via the score, satisfies a defined threshold, it transmits a corresponding indicator to the issuer 108. In turn, the issuer 108, generally, credits the appropriate amount to the consumer's payment account (without further investigation of the disputed transaction), if the issuer 108 has not already done so. Alternatively, when the engine 114 determines that the score associated with the refund request does not satisfy the defined threshold (e.g., is either too high, or too low, etc.), it transmits an appropriate indicator to the issuer 108 and/or the acquirer 104, as well as the refund request, via the payment network 106, for investigation and/or further processing as a chargeback transaction. For example, the acquirer 104 may initially attempt to investigate and/or resolve the dispute with the consumer 112. However, when that is not possible, the acquirer 104 may transmit the transaction to the merchant 102, who then accepts the chargeback, i.e., absorbs the cost/charge associated with the chargeback, or resubmits the charge for authorization and clearing (as previously described herein). If appropriate, the issuer 108 re-posts the transaction to the consumer's payment account. Otherwise, the acquirer 104 removes the disputed amount from the merchant's account (such that the merchant 102 suffers the loss), and reconciles as needed with the issuer 108.

For each of the above transactions, transaction data is generated, collected, and stored as part of the interactions among the merchant 102, the acquirer 104, the payment network 106, the issuer 108, and the engine 114. The transaction data represents at least a plurality of transactions, e.g., completed transactions, attempted transactions, etc. Depending on the transaction, the transaction data is transmitted from the merchant 102 to the issuer 108 through the payment network 106 or otherwise (e.g., as part of the authorization request, as part of the refund request, etc.). The transaction data, in this exemplary embodiment, is stored by (or at) at least one of the payment network 106 and the engine 114, in a data structure associated therewith, depending on the particular embodiment, etc. Additionally, or alternatively, the merchant 102, the acquirer 104, and/or the issuer 108 may store the transaction data, or part thereof, in memory 204. The transaction data may include, for example, payment account numbers, amounts of the transactions, merchant IDs, merchant category codes (MCCs), dates/times of the transactions, product identifiers, etc. It should be appreciated that more or less information related to processing, approving, and/or declining of transactions may be included in transaction data and stored within the system 100, at the acquirer 104, the payment network 106, the issuer 108, and/or the engine 114.

Other transactions in the system 100, involving one or more of the consumer 112, the merchant 102, or other merchants and/or other consumers accommodated by the system 100 but not shown, are also processed in similar manners to the above example transactions. Transaction data is also generated in connection with these additional transactions.

In various exemplary embodiments, consumers (e.g., consumer 112, etc.) involved in the different transactions herein agree to legal terms associated with their payment accounts, for example, during enrollment in their accounts, etc. In so doing, the consumers may agree, for example, to allow merchants, issuers of the payment accounts, payment networks, etc., to use data collected during enrollment and/or collected in connection with processing the transactions, subsequently for one or more of the different purposes described herein.

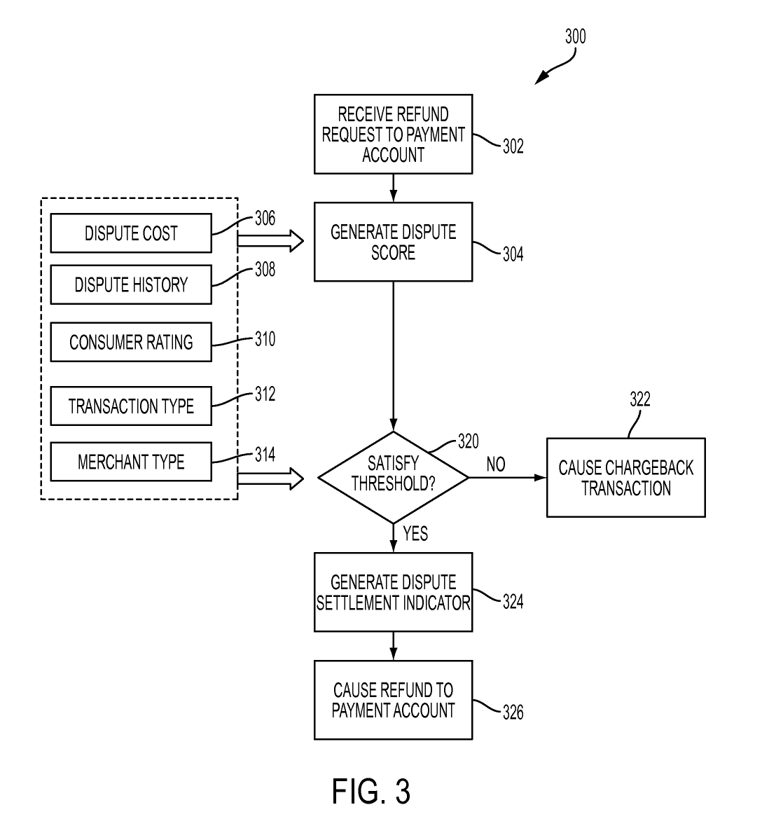

FIG. 3 illustrates exemplary method 300 that can be used in connection with the system 100 (or in connection with other systems herein) for processing disputed transactions, for example, involving incorrect charges to a payment account, etc. The exemplary method 300 is described as implemented in the engine 114 of the system 100, with further reference to the merchant 102, the acquirer 104, the payment network 106, the issuer 108, and the consumer 112. However, the method 300 could be implemented in one or more other entities, in other embodiments (e.g., in the payment network 106 of the system 100, in the issuer 108 of the system 100, etc.). Further, for purposes of illustration, the exemplary method 300 is described herein with reference to the computing device 200. Just as the method 300, and other methods herein, should not be understood to be limited to the exemplary system 100, or the exemplary computing device 200, the system 100 (and other systems) and the computing device 200 (and other computing devices) herein should not be understood to be limited to the exemplary method 300.

As shown in FIG. 3, in the method 300, when the consumer 112 suspects that an incorrect charge has been applied to his/her payment account, the consumer 112 submits a request for refund of an amount associated with the incorrect charge. In turn, the engine 114 receives the refund request, at 302. The request is received by the engine 114 at the computing device 200, via network 110, and is stored in memory 204. It should be appreciated that the refund request can include any desired data relating to the disputed transaction. For example, the refund request may include an amount of the transaction, an indication of the merchant 102 involved in the transaction (e.g., a name of the merchant 102, a merchant identification (MID) for the merchant 102, etc.), an indication of the consumer 112, an account number for the consumer's payment account, etc. In addition, the data may be provided by the consumer 112, or the data may include transaction data stored in the system 100 (e.g., at the issuer 108, at the payment network 106, etc.) and transmitted to the engine 114 via the network, etc.

Typically, the consumer 112 will submit the refund request to the issuer 108 of his/her payment account, for example, via the network 110 using computing device 200 associated with the consumer 112. The engine 114 will then receive the refund request from the issuer 108, for example, via the network 110. As necessary, the issuer 108 may provide additional data to the engine 114, in connection with the refund request, so that the engine 114 can process the request as described herein. However, it should be appreciated that the engine 114 may receive the refund request directly from the consumer 112 (e.g., directly via contact from the consumer 112, via an application program interface (API) from a website associated with the issuer 108, etc.), or from other entities shown in FIG. 1 (e.g., the merchant 102, etc.), or not shown.

Upon receiving the refund request, the engine 114 (e.g., the processor 202 associated with the engine 114, etc.) generates a dispute score for the request, at 304. The dispute score may be based on one or more different macro-factors, or variables, generally relating to the disputed transaction. For example, in the method 300, the dispute score may be based on the amount of the transaction in dispute and/or the cost to the issuer 108 (and/or other parts of system 100) to handle the dispute (generally, regardless of its outcome). Additionally, or alternatively, the engine 114 may take into account multiple other factors, at 308-314, to generate a dispute score for the request. In particular, the dispute score may be based on one or more of the following further variables: a dispute history for the payment account (and/or the consumer 112), at 308 (e.g., a number of prior disputed transactions submitted by the consumer 112, in general, or within a past interval (e.g., the last 30 days, the last 6 months, etc.), etc.); a rating for the consumer 112 (e.g., a consumer lifetime value for the consumer 112, transaction frequency for a consumer's payment account, longevity of the consumer's payment account, purchasing behavior for the consumer's payment account and/or the consumer 112, etc.), at 310; a type of transaction at 312 (e.g., card-not-present transactions, etc.); and a type of merchant 102, at 314 (e.g., based on a MCC for the merchant 102, based on other groupings of merchants into industry categories, etc.).

The dispute score may be generated in a number of different manners, which may depend, for example, on the availability of data to the engine 114, making the dispute score more or less precise and/or granular. In various embodiments, the dispute score is generated by one or more particular algorithms, such as described below, or alternatively, in other embodiments, the dispute score is generated by estimation, also as described below.

In various embodiments, the engine 114 generates the dispute score taking into account, among other variables, a lifetime value for the consumer 112 (broadly, a rating for the consumer 112). In so doing, purchasing behavior, generally, is a factor in evaluating interchange revenue and making predictions, or estimations, of consumer value for the consumer 112 based on risk and profitability. As such, the lifetime value for the consumer 112 may be calculated as a dollar amount, for example, as: (revenue from a revolving period+revenue from a delinquency period+revenue from collected fees)−(cost of maintenance for the consumer's payment account+cost of funds+potential loss due to default). With that said, it should be appreciated that different issuers may use different models to estimate such lifetime value for the consumer 112, and for other consumers, generally taking into account factors such as propensity of consumers to revolve, propensity of consumers to default, annual percentage rate (APR) forecasts, credit lines, etc. Other factors described herein may be similarly calculated in dollar values, for example, based on various models derived by issuers, etc.

In connection with generating the dispute score, then, an objective function or matrix may be constructed based on historical estimates of macro-factors, for example, a consumer value for the consumer 112 (broadly, a rating for the consumer 112) and an amount lost by the issuer 108 if the refunded amount is credited to the consumer 112 without an investigation (broadly, an amount of the disputed transaction, or cost). Assignment of the outcome to be modelled, for each past case, could then be shown in an outcome target matrix. Stated another way, a customer value and the amount lost for each of multiple (or all) disputed transactions (and often various other factors) over the six months, or last year (or other interval, regular or irregular), etc., may be determined, by the engine 114, and upon which a matrix is constructed. The matrix may be evenly distributed over the range in values, distributed to divide the disputes over the matrix, and/or a combination of both. The matrix may include any number of cells into which historic data may be segregated (in any manner), and thereby any granularity desired by the engine 114, issuer 108, or other part, etc.

An exemplary outcome target matrix, taking the two macro-factors for this example into account, is shown in Table 1.

TABLE 1

| | | Consumer Value | | |
|---|---|---|---|---|
| | | High | Medium | Low |
| Cost | High | 3 | 6 | 9 |
| | Medium | 2 | 5 | 8 |
| | Low | 1 | 4 | 7 |

In this example, the dispute score is the model that parameterizes all of the possible input that affect the two macro-factors, consumer value and an amount lost by the issuer 108 if the refunded amount is credited to the consumer 112 without an investigation. That is, because the model is often constructed apart from generating the dispute score, a more complete set of data may be compiled into and/or used to construct the matrix (including each or some of the factors described above). As such, the outcome target matrix, for example, shown in Table 1, is discretized into nine cells for only the two parameters (e.g., consumer value and cost), and yet still based on additional data processed by the engine 114. A place in a cell in the outcome target matrix is then a function of various factors such as, for example, consumer value, merchant rating, cost, etc.

Apart from the above exemplary matrix and understood variations, any suitable technique, or model, may be used to generate the dispute score. Generally, development of the model involves looking at the multiple prior refund disputes to mimic a known outcome, and then using predictive modeling and data mining techniques such as regressions, decision trees, machine learning algorithms, etc. to determine all the factors that impact the outcome and to find the weights and the direction of the predictors. However, it is contemplated that historical data may be used to construct and/or compile one or more thresholds (as described below), with the dispute score based on, in whole or in part, present data about the dispute, whereby the dispute score is less (or not) based on estimation, but real data regarding the request and the underlying disputed transaction (regardless of the number of factors relied upon). Moreover, the manner in which sub factors have an impact on the dispute score is the “direction” (positive or negative) of the factors. The extent of the impact is the “weight” of the sub factors. As such, the model translates changes in the values of the sub factors into an increasing or decreasing probability to be in a given target outcome cell (1 to 9) in the outcome target matrix.

Without limitation, as one example, the engine 114 may apply exemplary algorithm (1), or regression model, to generate a dispute score for the disputed charge to the consumer's payment account. In so doing, the engine 114 can make use of multiple different factors or variables to generate the dispute score. While the algorithm (1) is used with only the three factors in this example, more factors (or other factors) may be used in other examples (as generally indicated by βₙxₙ in the algorithm (1), for example). Further, regardless of the number of factors, it should further be appreciated that algorithm (1) is only exemplary in nature and that other models or algorithms may be used in other embodiments.

Y=β₀+β₁x₁+β₂x₂+β₃x₃+βₙxₙ (1)

Where the variables in the algorithm (1) are as follows, as would be recognized by a person of ordinary skill in the art:

Y=dispute score;

β₀=intercept;

x₁=first variable used in connection with generating the dispute score (e.g., a rating of a consumer, etc.);

β₁=coefficient (or weighting) applied to first variable x₁;

x₂=second variable used in connection with generating the dispute score (e.g., amount of the disputed transaction (or dispute cost), etc.);

β₂=coefficient (or weighting) applied to second variable x₂;

x₃=third variable used in connection with generating the dispute score (e.g., merchant type, etc.);

β₃=coefficient (or weighting) applied to third variable x₃;

xₙ=n^{th} variable used in connection with generating the dispute score (e.g., one or more other factors that may be used in connection with generating the dispute score, etc.); and

βₙ=coefficient (or weighting) applied to n^{th} variable xₙ.

In connection with algorithm (1), in this example, the dispute score is generated for the consumer 112 as follows. The rating of the consumer (x₁) of $45, as calculated above, is used in combination with a cost of pursing the dispute (x₂), which is provided as $25 in this example (e.g., taking into account the amount of the dispute and the related costs involved in processing the dispute, etc.) (the related cost may vary between different merchants and/or acquirers), along with a merchant type value (x₃) of $1, as calculated above. In addition, empirical or historical data (e.g., for the consumer 112, for the consumer's payment account, for the merchant 102, the payment network 107, the issuer 108, etc.) is processed via one or more fitting algorithms to generate (in the method 300, or separately) the β coefficients. The processing yields, in this exemplary embodiment, β₀ as 0.3, β₁ as 0.4, β₂ as −0.5, and β₃ as 0.2. The example dispute score for the consumer 112 is then $6. The dispute scores may then be segregated, by distribution, etc., into ranges, which defines the cells of the matrix of Table 1, for example.

It should be appreciated that the above algorithm (1) may be altered based on the particular factors used. Moreover, it should further be appreciated that while the dispute score is generated herein in dollar values, or as a monetary score, dispute scores may be in any format, monetary or not. But regardless of the format, the dispute score is generally based on one or more of the factors above.

After the matrix or other data structure, for example, is created based on multiple prior refund transactions, upon receipt of a refund request, the engine 114 generates the dispute score by determining the rating of the consumer and the cost of the refund request. The rating of the consumer, again, may be based on available payment account data about the consumer, a prior calculated rating for the consumer, etc. Similarly, the cost of the transactions may be based on available information about the merchant and/or acquirer (involved in the dispute transaction), prior calculated or otherwise determined cost associated with the merchant and/or acquirer, etc. Based on the rating and the cost, the engine 114 places the refund request in the matrix of Table 1 (e.g., based on scoring bands for high, medium and low in each axis, etc.), for example, thereby generating (and/or determining) a dispute score for the refund transaction, at 304.

Again, while algorithm (1) is contemplated for use in modelling the matrix in table 1, for example, the engine 114 may employ such an algorithm to generate dispute scores for requests, as received.

With reference again to FIG. 3, once the dispute score is determined, or generated, the model is deployed by the engine 114 as a score derived from the values and weights of the sub factors. The engine 114 next compares the generated dispute score to a score cutoff, or threshold (e.g., a defined threshold, etc.), at 320, to determine if the dispute score satisfies the threshold, for example, to determine if the dispute score is above or below the threshold or if it is greater than or less than the threshold. The threshold could be set, for example, at every case that has a probability of a target cell in the target matrix, etc.

Any additional actions taken by the engine 114, in connection with the method 300, are then generally determined by the resulting relationship between the dispute score and the threshold, as will be described in more detail hereinafter. As with the dispute score, the threshold can be based on one or more various different variables. Typically, though, the variables will represent empirical data, or historical estimates, for the consumer 112 or for the consumer's payment account. Example variables again include, without limitation, the cost of investigating the dispute, a rating of the consumer 112 (e.g., as determined above), amount of the disputed transaction, transaction frequency for the consumer's payment account, a type of the transaction, a type of the merchant 102 (e.g., based on a MCC for the merchant 102, etc.), and/or other factors identified herein, etc.

The threshold, to which the engine 114 compares the dispute score at 320, may be a static and generally fixed value (as identified by the engine 114, or by another). The engine 114 then determines on which side of the threshold value the dispute score falls, i.e., is the dispute score greater than the threshold value, or is the dispute score less than the threshold value. For example, for a threshold value of $30, when the engine 114 generates a dispute score of $25, the engine 114 determines, at 320, that the dispute score is less than the threshold value and takes appropriate action, as described more hereinafter. Or, the threshold may vary, for example, depending on one or more factors associated with the consumer 112, the consumer's payment account, the merchant involved, etc.

In numerous embodiments, one or more thresholds will be based on historical data related to disputes, and subjected to one or more algorithms to generate a dispute score. Specifically, as described above, disputed transactions for the last year (or other interval), may be subjected to the engine 114, from which a dispute score is generated (for example, according to algorithm (1)). While the dispute score of the historical data, as described above, may be used to generate a matrix for estimation of dispute scores for future disputed transactions, the historic dispute scores also reflect a distribution of the disputed transaction over the ranges of dispute scores represented in the matrix. With reference to Table 1, for example, the distribution of disputed transactions in the matrix may be reflected in Table 2, below, whereby the distribution of disputed transactions to issuer 108 (i.e., 2317 total disputes), for example, are shown. Additionally, the percentages of total disputed transactions are given.

TABLE 2

| | | |
|---|---|---|
| 1 | 36 | 1.5% |
| 2 | 61 | 2.6% |
| 3 | 23 | 1.0% |
| 4 | 241 | 10.4% |
| 5 | 167 | 7.2% |
| 6 | 125 | 5.3% |
| 7 | 754 | 32.5% |
| 8 | 631 | 27.2% |
| 9 | 279 | 12.1% |

Based on Table 2, the issuer 108 may determine a threshold for further investigating disputes. For example, the issuer 108 may decide not to investigate disputes for about 15% of disputes, prioritizing the most valued consumes. As such, because 1-3 correspond to the “high” valued customers, those transaction disputes would not be investigated. Because that leaves approximately 10%, the next valued consumers are medium customers 4-6, of which the cost of those disputes in cell 4 are the lowest. As such, the issuer 108 may determine, that a threshold of 4 is appropriate, and thus requests for disputed transaction falling into to cells 1-4 are not investigated and those falling into cells 5-9 are investigated further.

Additionally, or alternatively, if historically greater than 85% (or some other percentage of refund disputes) were granted over the last year (or other interval) after investigation, the issuer 108 may default to paying disputed transactions in that cell, rather than cause an investigation. It should be appreciated that any number of thresholds may be employed, relative to historical data (e.g., multiple prior refund transactions and their resolutions), etc.

It should be appreciated that historical data and matrixes, and/or other thresholds of various granularity may be used, by an issuer, for example, to decide which dispute to investigate, and which dispute to simply permit without investigation, as described below.

With continued reference to FIG. 3, when the dispute score does not satisfy the threshold, at 320, the engine 114 causes, or facilitates, a chargeback transaction at 322. In connection therewith, for example, the engine 114 may transmit chargeback transaction to the issuer 108 of the payment account associated with the consumer 112. In turn, the issuer 108 may then transmit the chargeback to the acquirer 104 who either resolves the dispute or forwards it to the merchant 102. When the chargeback is transmitted to the merchant 102, the merchant 102 either accepts the chargeback, i.e., absorbs the cost associated with the disputed transaction, or resubmits the underlying transaction for authorization and clearing. If the charge is resubmitted, the acquirer 104 again reviews the data received from merchant 102 and, as appropriate, either transmits the chargeback to the issuer 108 for posting to the consumer's payment account and/or debits the merchant's account for the amount of the charge.

However, when the dispute score satisfies the threshold, the engine 114 generates a dispute settlement indicator for the transaction at 324, without causing a chargeback transaction to the acquirer or the merchant. In connection therewith, the engine 114 causes a refund to the consumer's payment account, at 326, as appropriate. For example, the engine 114 may transmit the dispute settlement indicator to the issuer 108, and the issuer 108 may then generate a credit transaction to the consumer's payment account (funded by the issuer 108 or payment network 106) for the amount of the disputed transaction, instead of reviewing it or instead of initiating a chargeback transaction, which may involve communication and/or exchange of documents by and between with the merchant 102, the acquirer 104, and the consumer 112.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations described herein, including in the claims, such as, for example: (a) receiving a refund request from a consumer for a transaction, at a merchant, to a payment account associated with the consumer, the refund request including an amount of the transaction; (b) determining, by a computing device, a score for the refund request; (c) comparing, by the computing device, the score to a defined threshold, at least one of said score and said defined threshold based on at least one variable other than the amount of the transaction; and (d) generating, by the computing device, a dispute settlement indicator for the transaction, when the dispute score is less than the threshold, without causing a chargeback transaction to an acquirer associated with the merchant.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. In addition, as used herein, the term “and/or” includes any and all combinations of one or more of the associated listed items.

In addition, as used herein, the term product may include a good and/or a service.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for processing a transaction dispute from a consumer, the computer-implemented method comprising:
receiving a refund request from a consumer for a transaction, at a merchant, to a payment account associated with the consumer, the refund request including an amount of the transaction;
determining, by a computing device, a dispute score for the refund request;
comparing, by the computing device, the dispute score to a defined threshold, at least one of said dispute score and said defined threshold based on at least one variable apart from the amount of the transaction; and
generating, by the computing device, a dispute settlement indicator for the transaction, when the dispute score is satisfies the threshold, without causing a chargeback transaction to an acquirer associated with the merchant.

2. The computer-implemented method of claim 1, wherein the dispute score is the amount of the transaction; and
wherein the defined threshold is based on said at least one variable.

3. The computer-implemented method of claim 1, wherein the dispute score is based on one or more of a transaction frequency for the payment account, a dispute history for the payment account, and/or a rating of said consumer.

4. The computer-implemented method of claim 3, wherein the dispute score is based on a rating for the consumer and a cost of the refund; and
wherein the threshold is based at least in part of dispute scores for prior refund requests.

5. The computer-implemented method of claim 1, wherein the dispute score is determined based on at least a rating for said consumer and defined by a segregation of dispute scores of multiple historical refund requests.

6. The computer-implemented method of claim 1, wherein the dispute score is further based on the amount of the transaction and the at least one variable.

7. The computer-implemented method of claim 6, wherein said threshold includes a specific dispute score, or a range of dispute scores, whereby the dispute score satisfies the threshold when the dispute score equals the threshold, or is within the ranges of disputed scores.

8. The computer-implemented method of claim 1, further comprising transmitting the dispute settlement indicator to an issuer of the payment account associated with the consumer.

9. The computer-implemented method of claim 1, further comprising generating a credit transaction to the consumer's payment account for the transaction, when the dispute settlement indicator is generated for the transaction.

10. The computer-implemented method of claim 9, wherein the credit transaction is for the amount of the transaction.

11. The computer-implemented method of claim 1, wherein determining a dispute score for the refund request includes determining the dispute score based on an algorithm that relies on the amount of the transaction and said at least one variable; and
wherein the at least one variable includes a transaction rating of the consumer.

12. A system for use in processing a transaction dispute from a consumer, the system comprising:
a memory configured to store at least one refund threshold for use in determining whether or not to cause a refund in connection with a transaction dispute; and
a processor coupled to the memory and configured to:
receive a refund request from a consumer for a transaction to a payment account associated with the consumer, the refund request including an amount of the transaction and an indication of a merchant involved in the transaction;
generate a dispute score for the refund request based on at least on variable associated with the consumer;
compare the dispute score to a threshold, at least one of the dispute score and the threshold based on a rating of the consumer;
cause a refund to the payment account associated with the consumer when the dispute score satisfies the threshold, but without causing a chargeback transaction to an acquirer; and
initiate a chargeback transaction when the dispute score does not satisfy the threshold.

13. The system of claim 12, wherein the dispute score is the amount of the transaction.

14. The system of claim 12, wherein the dispute score is based, at least in part, on one or more of the amount of the transaction, a rating of the consumer, a dispute history for the payment account, a type of the transaction, and a type of the merchant.

15. The system of claim 12, wherein the processor is configured to generate the dispute score based on a rating of the consumer and a cost associated with the refund request, as compared to a historical matrix of prior refund transactions.

16. The system of claim 12, wherein the threshold is based, at least in part, on the amount of the transaction and the rating of the consumer.

17. A non-transitory computer readable storage media including executable instructions which, when executed by at least one processor, cause the at least one processor to:
generate a dispute score, in response to a refund request from a consumer for a transaction to a payment account associated with the consumer, the dispute score based on at least one variable apart from, or in addition to, an amount of the transaction;
compare the dispute score to a defined threshold;
generate a dispute settlement indicator for the transaction, when the dispute score is less than the defined threshold, without causing a chargeback transaction to an acquirer associated with the merchant, and cause a refund to the consumer's payment account for the transaction; and
cause a chargeback transaction when the dispute score does not satisfy the defined threshold.

18. The non-transitory computer readable storage media of claim 17, wherein the executable instructions, when executed by the at least one processor, further cause the at least one processor to transmit the refund request to an issuer of the payment account associated with the consumer, in connection with causing the chargeback transaction.

19. The non-transitory computer readable storage media of claim 17, wherein the dispute score is further based, at least in part, on one or more of the amount of the transaction, a type of the transaction, and a type of a merchant involved in the transaction.

20. The non-transitory computer readable storage media of claim 17, wherein the threshold is based, at least in part, on dispute scores for multiple prior refund requests.
